(19) United States
(12) Patent Application Publication
(10) Pub. No.: US 2005/0287304 A1
(43) Pub. Date: Dec. 29, 2005

(54) Method of treating a substrate for electroless plating and method of increasing adhesion therebetween, and magnetic recording medium and magnetic recording device thereof

(75) Inventors: Akira Iso, Nagano (JP); Youichi Tei, Nagano (JP); Kazuhito Higuchi, Nagano (JP)

Correspondence Address: ROSSI, KIMMS & McDOWELL LLP., P.O. BOX 826, ASHBURN, VA, 20146-0826, US

(73) Assignee: Fuji Electric Device Technology Co.,, Shinagawa-ku (JP)

(21) Appl. No.: 11/149,430

(22) Filed: Jun. 10, 2005

(30) Foreign Application Priority Data
Jun. 11, 2004 (JP) 2004-174690

(51) Int. Cl. B05D 1/18

(52) U.S. Cl. 427/430.1; 427/437

(57) ABSTRACT

The method of increasing adhesion between a substrate and an electroless plating layer, and treating the substrate for electroless plating, includes removing any excess alkali from the surface of the substrate, etching the surface of the glass substrate, forming an adhesion layer, forming a catalyst layer on the adhesion layer, and forming an electroless plating film on the catalyst layer.

### BACKGROUND

An aluminum alloy substrate and a nonmagnetic Ni—P film formed on the substrate by a plating method have been generally used in a magnetic recording medium (HD) for a magnetic recording device (hard disk drive: HDD), such as for an external storage device of a computer. However, with the increasing recording density and decreasing diameter of the HD (HDD) in recent trends, glass substrates have been contemplated as they have desirable properties, namely the flatness and strength.

Unfortunately, it is almost impossible to form a metallic film directly on a glass substrate by a plating method. Accordingly, when using a glass substrate, an underlayer of Ni—P or the like is formed by a sputtering method. Since the adhesivity between glass and metal composing the underlayer is poor, direct deposition of the underlayer on the glass substrate is difficult. Consequently, in practical application, a layer containing titanium or chromium, which is superior among metals in the adhesivity with glass, is formed on the glass substrate as an adhesion layer, and an underlayer film is deposited on the adhesion layer. Even with the titanium or chromium adhesion layer, because its adhesivity to glass is not great, a thick film of an underlayer or an adhesion layer causes low adhesivity due to the difference in expansion coefficients.

A perpendicular magnetic recording medium, which is actively being developed recently, needs a relatively thick layer of soft magnetic underlayer in a range of 0.3 μm to 3.0 μm thick. Forming this soft magnetic underlayer by a sputtering method causes the problems of low adhesivity and high costs. A method of forming a plating film on a surface of a glass substrate has been proposed in Japanese Unexamined Patent Application Publication No. 2000-163743, for example, in which a treatment with a silane coupling agent is conducted and then, an electroless plating film is formed. When a silane coupling agent is dissolved in water, an ethoxy group or a methoxy group of the silane coupling agent changes into a silanol group. The silanol group forms a bond, like a hydrogen bond, with a hydroxy group on the glass substrate surface. By a dehydration treatment, the bond between the silanol group and the hydroxy group is considered to be a strong chemical bond.

A glass substrate used in a magnetic recording medium is generally strengthened by a chemical strengthening treatment for the purpose of improving the shock resistance and the vibration resistance and preventing the substrate from the damage from the shock and vibration. The chemical strengthening treatment is carried out for example, by dipping the glass substrate surface in a fused salt of sodium nitrate and potassium nitrate. The chemical strengthening treatment, however, is liable to leave many alkali metal ions of sodium ions and potassium ions on the substrate surface. Excessive alkali metal ions existing on the glass substrate surface bond with OH groups on the substrate surface and inhibit the bonding between the glass and the silane coupling agent, causing low adhesivity. Thus, an alkali removal treatment is conducted as one of the pre-treatments before the treatment with a silane coupling agent. A method of the alkali removal treatment has been proposed in Japanese Unexamined Patent Application Publication No. H10-226539, for example, in which a glass substrate after a chemical strengthening treatment is dipped and cleaned in warm water, and further dipped in hot concentrated sulfuric acid.

The present inventors performed the plating treatment according to the previously described publication (2000-163743) on a substrate having a surface roughness Ra of not smaller than 10 nm. No problem in adhesivity occurred in such a rough glass substrate. On the other hand, an electroless Ni—P plating film was deposited on a glass substrate having surface roughness Ra in the range of 0.2 to 1.0 nm to obtain a plating film 2 μm thick, and subjected to a cross-cut test. The test revealed inadequate adhesion, resulting in detachment of the film. The surface roughness Ra required by a glass substrate now is at most 0.5 nm, and in a perpendicular magnetic recording medium, still smaller roughness is desired. Therefore, a method of treating the substrate for plating is eagerly demanded at present that can provide a plating film of excellent adhesivity on a glass substrate having very small surface roughness. Indeed, an alkali removal treatment to dip in hot concentrated sulfuric acid as disclosed in the second publication mentioned above can destroy the skeleton of glass.

Accordingly, there still remains a need for a technique for promoting good adhesion between metal layer and a substrate with a very small surface roughness. The present invention addresses this need.

### SUMMARY OF THE INVENTION

The present invention relates to a method of treating a substrate for electroplating and a method of improving adhesion between a substrate and a metal layer, and a magnetic recording medium and a magnetic recording device using the magnetic recording medium thereof.

One aspect of the present invention is a method of treating a substrate for electroplating. Another aspect is a method of improving adhesion between a substrate and a metal layer. The substrate can be made of glass.

Both methods include removing excessive alkali on a surface of the substrate, etching the surface of the substrate from which the excessive alkali has been removed in the alkali removal step, forming an adhesion layer on the substrate after the etching step, forming a catalyst layer using palladium chloride or palladium on the adhesion layer on the substrate, and forming an electroless plating film on the catalyst layer.

The alkali removing step can include immersing the substrate in a solution containing lithium salt. The etching step can include immersing the substrate in a solution containing hydrofluoric acid, ammonium fluoride, hydrochloric acid, or a mixture of two or more thereof. The adhesion layer formation step can include immersing the substrate in an aqueous solution of amino-type silane coupling agent or mercapto-type silane coupling agent. The etching step can include immersing the substrate in an aqueous solution of potassium hydroxide, before immersing the substrate in the solution containing hydrofluoric acid, ammonium fluoride, hydrochloric acid, or a mixture of two or more thereof. The temperature of the solution containing lithium salt in the alkali removal step can be in a range of 100° C. to 200° C.

Another aspect of the invention is a magnetic recording medium including the substrate with the plating film formed as described above. Another aspect of the invention is a magnetic recording device containing the magnetic recording medium described above.

### BRIEF DESCRIPTION OF THE DRAWINGS

FIG. 1 shows the effects of the treatment time and the treatment liquid temperature in the alkali removal step on the classification level in the cross-cut test.

FIG. 2 shows the effect of the pre-etching treatment at each treatment time of the alkali removal step.

FIG. 3 shows the effect of the type of the treatment liquid in the etching step (2) on the classification level in the cross-cut test.

FIG. 4 shows a comparison between the combination of amino-type silane coupling agent and palladium chloride and the combination of mercapto-type silane coupling agent and palladium.

### DETAILED DESCRIPTION

The present method forms a plating film having excellent adhesivity on a smooth surfaced substrate, even on a glass substrate having very small surface roughness, not larger than 0.5 nm. Thus, coarsening of the substrate surface can be omitted, while forming a highly reliable magnetic recording medium and a magnetic recording device using such a magnetic recording medium. Since a magnetic layer in a magnetic recording medium of the invention can be adhered to the substrate, the magnetic recording device using the medium also exhibits excellent reliability.

The present method includes an alkali removal step for removing excessive alkali metal ions on the glass substrate surface. Note that excessive alkali metal ions of sodium ions and potassium ions introduced on the surface in a chemical strengthening treatment inhibit the bonding between the glass and the silane coupling agent. Although a glass substrate is described here, other substrates have similar properties can be used as a substrate for forming a magnetic recording medium. The glass substrate is preferably chemically strengthened to improve shock and vibration resistance. The surface roughness Ra of the substrate is preferably not larger than 0.5 nm for the use in a magnetic recording medium.

The alkali removal step includes dipping, immersing, or submerging the glass substrate in a solution containing lithium salt, which can be selected from nitrate, sulfate, carbonate, phosphate, chloride, and fluoride of lithium, and a mixture of two or more of these substances. Among these types of lithium salt, lithium nitrate is particularly favorable. A favorable lithium salt solution is an aqueous solution of lithium salt. Note that the term “dipping” or “immersed” used throughout the disclosure refers to and includes any and all situations where the substrate is covered with the treatment solution. The glass substrate surface is desirably homogeneously treated during the dipping process of the glass substrate, and can be dipped or immersed with the glass substrate held at the end surface. Ultrasonic wave can be applied during the treatment.

When a glass substrate is dipped in a lithium salt solution, the lithium ions in the solution perform the ion-exchange with the sodium ions and potassium ions on the glass substrate surface, and bind to un-crosslinked oxygen. A lithium ion has a smaller ionic radius than a sodium ion and a potassium ion, and exhibits a larger bonding force of ionic bond with oxygen than a sodium ion and a potassium ion. Therefore, an alkali removal treatment using the lithium ions removes sodium ions and potassium ions on the glass substrate surface, and further, effectively suppresses dissolution of the alkali from the glass substrate in the later processes.

The spot where the sodium ion or the potassium ion is removed becomes a cavity with a complicated shape, not a dent of simple form, in the dipping process in the lithium salt solution. By adjusting the size of the cavities to fit with a silane coupling agent, a nucleus of a catalyst, and a plating film in the etching treatment described later, a plating film exhibiting the efficient anchoring effect and the firm adhesion can be obtained.

Though the temperature of the lithium salt solution has no specific limitation, a relatively high temperature is favorable because of a good treatment effect. On the other hand, too high temperature of the lithium salt solution is liable to cause relaxation of the strain generated in the chemical strengthening treatment and possibly lowers the strength. From this viewpoint, the temperature of the lithium salt solution can be preferably in the range of 100° C. to 200° C., more preferably in the range of 130° C. to 200° C.

Because the boiling point of the aqueous solution rises as a concentration of the lithium salt increases, the state of aqueous solution is maintained still in the above-mentioned temperature range. Too high concentration, however, possibly causes precipitation of the salt on the glass substrate surface even in the above-mentioned temperature range. From this viewpoint, the concentration of the lithium salt solution can be preferably in the range of 50 to 80%.

The glass substrate can be pre-heated up to a temperature near the temperature of the lithium salt solution, for example to a temperature in the range of 100° C. to 130° C. The dipping time of the glass substrate in the lithium salt solution is preferably in the range of 60 min to 3 hr, although there is no specific limitation. Time duration shorter than the lower limit is liable to insufficiently remove alkali. Time duration longer than the upper limit does not further remove alkali, and thus is wasteful.

Following the dipping treatment, the substrate can be scrubbed clean using neutral detergent and sponge, cleaned with alkali detergent, rinsed with ultra high purity water, and steam dried using a hydrophilic and volatile organic solvent, such as isopropyl alcohol.

After the dipping treatment, and any of the scrubbing, cleaning, rinsing, and steam drying steps, namely after the excess alkali has been removed from the substrate, the substrate is etched. The etching step includes treating the surface of the glass substrate with a solution, which can be an aqueous solution, containing hydrofluoric acid, ammonium fluoride, hydrochloric acid, or a mixture of two or more of these substances. The etching treatment removes the oxide film existing on the glass substrate, and forms a new oxide film. The etching treatment modifies the cavities with a complicated shape generated after the ion-exchange of alkali ions in the dipping treatment in lithium salt solution, to a size fitting the silane coupling agent, a nucleus of the catalyst, and a plating film. Thus, a plating film that exhibits an efficient anchoring effect and stiff adhesivity can be obtained. The treatment with hydrofluoric acid, ammonium fluoride, and hydrochloric acid has an activation effect of increasing number of hydroxyl groups on the glass surface.

The treatment with a solution containing hydrofluoric acid, ammonium fluoride, hydrochloric acid, or a mixture of two or more of these substances, can be carried out by dipping or immersing the substrate in a solution containing hydrofluoric acid, ammonium fluoride, hydrochloric acid, or a mixture of two or more of these substances. Dipping or immersing of the glass substrate is desirably conducted with the glass substrate surface treated homogeneously. Dipping or immersing can be conducted while holding the end surface of the glass substrate, for example. Ultrasonic wave can be applied during the treatment.

The concentration of the aqueous solution of hydrofluoric acid, ammonium fluoride, hydrochloric acid, or a mixture of two or more of these substances can be in the range of 1 to 50 g/liter. The preferable treatment temperature is from the room temperature to 50° C., and the preferable treatment time is from 1 to 5 min.

The glass substrate, after the treatment with a solution containing hydrofluoric acid, ammonium fluoride, hydrochloric acid, or a mixture of two or more of these substances, is preferably rinsed enough with pure water and, without drying, proceeds to the next process, namely the adhesion layer forming step.

The etching step can include treating the glass substrate with an aqueous solution of potassium hydroxide, as a pre-treatment, before the process of treating with the solution of hydrofluoric acid or the other. The pre-treatment with the aqueous solution of potassium hydroxide can further improve adhesivity of the plating film. The pre-treatment can be carried out by dipping or immersing the glass substrate in the aqueous solution of potassium hydroxide. Ultrasonic wave can be applied during the treatment. Dipping or immersing of the glass substrate is desirably conducted with the glass substrate surface treated homogeneously. Dipping or immersing can be conducted holding the end surface of the glass substrate, for example. Preferable concentration of the aqueous solution of potassium hydroxide in the process of treatment with the aqueous solution of potassium hydroxide is in the range of 50 to 100 g/liter. The preferable treatment temperature is from the room temperature to 50° C., and the preferable treatment time is from 1 to 5 min. The glass substrate after the pre-treatment is preferably rinsed with enough pure water and, without drying, is treated with the solution of hydrofluoric acid or the other.

Even though pre-treated with potassium hydroxide, the glass substrate can be then treated with the solution of hydrofluoric acid, ammonium fluoride, hydrochloric acid, or a mixture of two or more of these substances. Thus, any residual potassium and alkali component will not likely remain on the surface of the glass substrate. The above step removes alkali components from the substrate surface and activates the surface so that a silane coupling agent easily binds to the substrate surface.

The adhesion layer formation step includes a silane coupling treatment with an aqueous solution of an amino-type silane coupling agent or a mercapto-type silane coupling agent on the glass substrate treated after the etching step. The silane coupling agent is trialkoxy substituted alkyl silane. A substituent of the alkyl group can be a functional group such as an amino group, halogen, an epoxy group, a mercapto group, or a vinyl group. The silane coupling agent having a functional group of amino group or mercapto group is used in the invention because those agents exhibit a strong bond with a metal ion. Namely, an amino-type silane coupling agent or a mercapto-type silane coupling agent can be used. The mercapto group has a feature that easily bonds with a metal ion, and the bonding strength is larger than the bonding strength between an amino group and a metal ion. Accordingly, the mercapto-type silane coupling agent is superior. An aqueous solution of silane coupling agent can contain acetic acid, and can be a solution containing a mixture of methanol and water.

The amino-type silane coupling agents include:
N-(2-aminoethyl)-3-aminopropylmethyl dimethoxy silane,
N-(2-aminoethyl)-3-aminopropyl trimethoxy silane,
N-(2-aminoethyl)-3-aminopropyl triethoxy silane,
3-aminopropyl trimethoxy silane,
3-aminopropyl triethoxy silane,
3-triethoxysilyl-N,N-(1,3-dimethylbutylidene) propylamine N-phenyl-3-aminopropyl trimethoxy silane,
1-(3-aminopropyl)-1,1,3,3,3-pentamethyl disiloxane, and
3-aminopropyl tris (trimethylsiloxy) silane.

The mercapto-type silane coupling agents include:
3-mercaptopropyl methyl dimethoxy silane,
3-mercaptopropyl trimethoxy silane,
1,3-bis (mercaptomethyl)-1,1,3,3-tetramethyl disiloxane, and
1,3-bis (3-mercaptomethyl)-1,1,3,3-tetramethyl disiloxane.

A silane coupling treatment can be carried out by dipping or immersing the glass substrate in an aqueous solution of a silane coupling agent. The dipping or immersing of the glass substrate is favorably conducted with the glass substrate surface treated homogeneously, and holding the glass substrate at the end surface thereof. Ultrasonic wave can be applied during the treatment. The concentration of the aqueous solution of silane coupling agent in the adhesion layer formation step can be in the range of 10 to 20 mL/L, and the treatment time can be in the range of 1 to 5 min. The glass substrate treated with the silane coupling agent is enough rinsed with pure water, and preferably, without drying, proceeds to the next treatment, which is a catalyst layer formation step.

The catalyst layer formation step forms a catalyst layer using palladium chloride or palladium on the adhesion layer formed in the silane coupling treatment. The palladium chloride or the palladium bonds to the amino group or the mercapto group, which is a functional group of the silane coupling agent, through a coordinate bond or the like. Since a silane coupling agent of amino-type silane coupling agent is positively charged in an aqueous solution, the catalyst layer formation is preferably carried out using palladium chloride. On the other hand, a mercapto-type silane coupling agent is negatively charged in an aqueous solution, so that the catalyst layer formation is preferably carried out using colloidal palladium.

The catalyst layer can be formed by dipping or immersing a glass substrate in an aqueous solution containing a catalyst component of palladium chloride or the like. The dipping or immersing of the glass substrate is appropriately conducted with the glass substrate surface treated homogeneously, and favorably holding the glass substrate at the end surface. During the treatment, ultrasonic wave can be applied. After dipping or immersing in the aqueous solution containing a catalyst component, the glass substrate is sufficiently rinsed, and then excessively adhered catalyst component is preferably removed from the glass substrate.

The removing process can be carried out for example, by dipping or immersing the glass substrate with the catalyst layer in an aqueous solution of hypophosphorous acid. After the process, the glass substrate is sufficiently rinsed with pure water and then, preferably without drying, proceeds to the next process, which is the electroless plating step.

On the thus treated glass substrate surface, the electroless plating step forms a plating film of for example, a nonmagnetic Ni—P film, a soft magnetic Ni—P film, or a soft magnetic CoNiP film. No special limitations are imposed on the plating conditions in the electroless plating step, and any commonly used electroless plating conditions can be employed. The thickness of the plated film is preferably from 1 to 2 μm. The thickness can be appropriately controlled by adjusting the plating conditions including the duration of the plating.

After the substrate is plated, it can be scrubbed clean using neutral detergent and sponge, cleaned with alkali detergent, rinsed with ultrahigh purity water, and steam dried using a hydrophilic and volatile organic solvent, such as isopropyl alcohol.

A perpendicular magnetic recording medium can be produced by forming an underlayer of for example chromium, a magnetic layer of for example Co—Cr—Pt—SiO₂, and a protective layer of for example carbon by a sputtering method according to common techniques, on a disk-shaped glass substrate having for example a soft magnetic plating film. A lubricant layer can be formed on the protective layer using a fluorine-containing liquid lubricant. No special limitation is imposed on the processes to form these layers, and the processes can be carried out by known techniques.

A magnetic recording medium obtained by a method of the invention, exhibiting excellent adhesivity, is also suited to perpendicular magnetic recording. A hard disk drive system can a motor for rotating a magnetic recording medium using a disk-shaped glass substrate having a plating film (namely a hard disk), a magnetic head floating on the hard disk, which head reads and writes signals on the hard disk. The hard disk drive according to the invention can enhance recording density using a glass substrate with low surface roughness.

Some specific examples embodying the present invention follow. In Example 1, the glass substrate used was a chemically strengthened glass substrate with a disk shape made of aluminosilicate amorphous glass. The surface roughness Ra of the substrates is given in Table 2. The surface roughness Ra was measured by an AFM (atomic force microscope).

(I) Glass Substrate Surface Treatment

1. Alkali Removal Step

A treatment liquid for this step was prepared by adding 2,600 g of LiNO₃ to 1,000 mL of pure water and heating this aqueous solution to 100° C. After preheating up to 100° C., the glass substrate was dipped in the treatment liquid for 60 min. The dipping or immersing was conducted holding the glass substrate at the end surface so that the glass substrate surface can be treated homogeneously. The glass substrate after the alkali removal treatment described above, was scrub-cleaned using a neutral detergent and a PVA sponge, and then cleaned using an alkali detergent (2% Semi Clean pH=12, manufactured by Yokohama Oils and Fats Industry Co., Ltd.). After the cleaning, the glass substrate was rinsed sufficiently using ultrahigh purity water with a resistivity of at least 18 MQ, and then dried with isopropyl alcohol vapor.

2. Etching Step (1)

The glass substrate was dipped in an aqueous solution of potassium hydroxide, as a pre-treatment of an etching step. A treatment liquid of this pre-treatment was prepared by adding 150 g of KOH to 2,000 mL of pure water and heating the aqueous solution up to 50° C. The glass substrate after the alkali removal treatment was dipped in the treatment liquid for 5 min. The dipping or immersing was conducted holding the glass substrate at the end surface so that the glass substrate surface can be treated homogeneously. The glass substrate after the above treatment was sufficiently rinsed with pure water and, without drying, proceeded to the next treatment.

3. Etching Step (2)

The glass substrate was dipped in an aqueous solution of ammonium fluoride. A treatment liquid for this step was prepared by adding 400 mL of 480B (a product of Meltex Inc.) and 40 g of 480A (a product of Meltex Inc.) into 2,000 mL of pure water. The glass substrate was dipped in this treatment liquid of the aqueous solution for 5 min, to enhance the physical anchoring effect. The dipping or immersing was conducted holding the glass substrate at the end surface so that the glass substrate surface can be treated homogeneously. The glass substrate after the above treatment was sufficiently rinsed with pure water and, without drying, proceeded to the next treatment.

4. Adhesion Layer Formation Step

An aqueous solution of treatment liquid was prepared by adding 20 mL of amino-type silane coupling agent KBE903 (a product of Shin-Etsu Chemical Co., Ltd.) into 2,000 mL of pure water. The glass substrate was dipped in the treatment liquid for 4 min, to form an adhesion layer of silane coupling agent. The dipping or immersing was conducted holding the glass substrate at the end surface so that the glass substrate surface can be treated homogeneously. The glass substrate after the above treatment was sufficiently rinsed with pure water and, without drying, proceeded to the next treatment.

5. Catalyst Layer Formation Step

An aqueous solution of treatment liquid was prepared by adding 60 mL of aqueous solution of palladium chloride (trade name Activator 7331, a product of Meltex Inc.) and 3 mL of KOH with the concentration of 0.1 mol/L into 2,000 mL of pure water. The glass substrate was dipped in the treatment liquid for 4 min. The dipping or immersing was conducted holding the glass substrate at the end surface so that the glass substrate surface can be treated homogeneously. The glass substrate after the above treatment was sufficiently rinsed with pure water and, without drying, proceeded to the next treatment.

6. Removal of Excessive Palladium and Metallization of Palladium

An aqueous solution of treatment liquid was prepared by adding 20 mL of an aqueous solution of hypophosphorous acid (trade name PA7340, a product of Meltex Inc.) into 2,000 mL of pure water. The glass substrate was dipped in the treatment liquid for 2 min. The dipping or immersing was conducted holding the glass substrate at the end surface so that the glass substrate surface can be treated homogeneously. The glass substrate after the above treatment was sufficiently rinsed with pure water and, without drying, proceeded to the next treatment.

(II) Electroless NiP Plating Step

The substrate after the surface treatment was dipped for 8 min in an electroless Ni—P plating solution LPH—S (manufactured by Okuno Chemical Industries Co., Ltd.) heated up to 85° C. to deposit a soft magnetic NiP plating film 2 μm thick. The glass substrate after completion of the deposition processes was then cleaned by scrub cleaning using neutral detergent and a PVA sponge and by alkali detergent cleaning (2% Semi Clean, pH=12, manufactured by Yokohama Oils and Fats Industry Co., Ltd.), rinsed with ultrahigh purity water with resistivity at least 18 MQ, and dried with isopropyl alcohol vapor. The surface roughness of the glass substrate after the surface treatment was measured by an AFM. The results are given in Table 2.

(III) Steps of Depositing a Magnetic Recording Layer and a Protective Layer:

A perpendicular magnetic recording medium was manufactured by sequentially forming a chromium underlayer, a magnetic layer of Co—Cr—Pt—SiO₂, and a carbon protective layer according to a common sputtering method on the glass substrate after the treatment as described above. A magnetic recording medium is generally applied with a fluorine-containing lubricant on the protective layer. But the lubricant layer was not applied for evaluating adhesivity through the peeling-off with a tape. These treatment conditions are summarized in Table 1.

TABLE 1
TREATMENT CONDITIONS
EXAMPLE 1

| | | | | |
|---|---|---|---|---|
| 1 | LiNO₃ | 60 | min | |
| 2 | KOH | 5 | min | rinsing with water |
| | | | | for 2 min |
| 3 | acid treatment | 5 | min | rinsing with water |
| | | | | for 2 min |
| 4 | adhesion layer formation | 4 | min | rinsing with water |
| | | | | for 2 min |
| 5 | catalyst layer formation | 4 | min | rinsing with water |
| | | | | for 2 min |
| 6 | H₃PO₂ | 2 | min | rinsing with water |
| | | | | for 2 min |

| | |
|---|---|
| PLATING | Ni—P 85° C. 8 min (about 2 μm) |
| MEDIUM | Underlayer/Magnetic Layer/Protective Layer/ |

The results of the cross-cut tests are given in Table 2. Cross-cut tests were conducted on the obtained magnetic recording media according to JIS (Japanese Industrial Standards) K5600-3-4. The classification of the cross-cut test results is as follows.

Classification of Test Results (adhesivity is lowest at level 1 and highest at level 5).
Level 1: An adhesive tape is applied onto the surface of the magnetic recording medium before cross cutting. When the tape is pulled off at a speed of 1 mm/sec, the Ni—P layer and the upper layers are detached adhering to the adhesive tape.
Level 2: Some parts are detached by only cross cutting (2 mm×2 mm).
Level 3: Wholly detached by pulling off the adhesive tape after cross cutting.
Level 4: Partially detached by pulling off the adhesive tape after cross cutting.
Level 5: No part is detached by pulling off the adhesive tape after cross cutting.

In Example 2 and 3, the surface treatment of a glass substrate, the manufacture of a magnetic recording medium, and the evaluation were carried out in the same manner as in Example 1, except that the dipping or immersing time in the treatment solution in the alkali removal step was 120 min and 180 min, respectively.

In Examples 4-6, the surface treatment of glass substrates, the manufacture of magnetic recording media, and the evaluation were carried out in the same conditions as in Examples 1-3, except that the temperature of the treatment solution in the alkali removal step was 150° C. Examples 4, 5, and 6 correspond to Examples 1, 2, and 3, respectively.

In Examples 7-9, the surface treatment of glass substrates, the manufacture of magnetic recording media, and the evaluation were carried out in the same conditions as in Examples 1-3, except that the temperature of the treatment solution in the alkali removal step was 200° C. Examples 7, 8, and 9 correspond to Examples 1, 2, and 3, respectively.

In Example 10, the surface treatment of a glass substrate, the manufacture of a magnetic recording medium, and the evaluation were carried out in the same manner as in Example 5, except that the aqueous solution of ammonium fluoride in the etching step (2) was replaced by an aqueous solution of hydrofluoric acid prepared by adding 400 mL of 1% hydrogen fluoride in 2,000 mL of pure water.

In Example 11, the surface treatment of a glass substrate, the manufacture of a magnetic recording medium, and the evaluation were carried out in the same manner as in Example 5, except that the aqueous solution of ammonium fluoride in the etching step (2) was replaced by an aqueous solution of diluted hydrochloric acid prepared by adding 400 mL of 1% hydrochloric acid in 2,000 mL of pure water.

In Examples 12-14, the surface treatment of glass substrates, the manufacture of magnetic recording media, and the evaluation were carried out in the same manner as in Examples 4-6, except that the step of etching (1) was omitted. Examples 12, 13, and 14 correspond to Examples 4, 5, and 6, respectively.

In Examples 15-17, the surface treatment of glass substrates, the manufacture of magnetic recording media, and the evaluation were carried out in the same manner as in Examples 4-6, except that the amino-type silane coupling agent in the adhesion layer formation step was replaced by a mercapto-type silane coupling agent of the same amount of KBM803, and the aqueous solution of palladium chloride in the catalyst formation step was replaced by colloidal palladium. Examples 15, 16, and 17 correspond to Examples 4, 5, and 6, respectively.

In Comparable Examples 1 and 2, the surface treatment of a glass substrate, the manufacture of a magnetic recording medium, and the evaluation were carried out in the same manner as in Examples 5 and 16, respectively, except that the alkali removal step was omitted.

Table 2 shows the surface roughness (Ra) before and after the surface treatment of the glass substrates of the Examples and Comparative Examples, and the observed classification level in the cross-cut test. The values of surface roughness are the data on one face/one sheet treated for the roughness measurement, and the values of the classification level of the cross-cut test are data on four faces/two sheets and the mean values thereof.

TABLE 2
TEST RESULTS

| | SURFACE | | | | | | |
|---|---|---|---|---|---|---|---|
| | ROUGHNESS Ra [nm] | | | | | | |
| | BEFORE | AFTER | CLASSIFICATION LEVEL IN CROSS-CUT TEST | | | | |
| | TREATMENT | TREATMENT | MEAN | DISK 1 A | DISK 1 B | DISK 2 A | DISK 2 B |
| EXAMPLE 1 | 0.22 | 0.43 | 3.5 | 3 | 4 | 4 | 3 |
| EXAMPLE 2 | 0.22 | 0.48 | 3.75 | 4 | 4 | 4 | 3 |
| EXAMPLE 3 | 0.23 | 0.44 | 4.25 | 4 | 5 | 4 | 4 |
| EXAMPLE 4 | 0.22 | 0.44 | 4.5 | 4 | 5 | 5 | 4 |
| EXAMPLE 5 | 0.23 | 0.44 | 5 | 5 | 5 | 5 | 5 |
| EXAMPLE 6 | 0.23 | 0.44 | 5 | 5 | 5 | 5 | 5 |
| EXAMPLE 7 | 0.24 | 0.49 | 4.75 | 4 | 5 | 5 | 5 |
| EXAMPLE 8 | 0.26 | 0.48 | 5 | 5 | 5 | 5 | 5 |
| EXAMPLE 9 | 0.24 | 0.49 | 5 | 5 | 5 | 5 | 5 |
| EXAMPLE 10 | 0.25 | 0.48 | 5 | 5 | 5 | 5 | 5 |
| EXAMPLE 11 | 0.28 | 0.42 | 5 | 5 | 5 | 5 | 5 |
| EXAMPLE 12 | 0.26 | 0.33 | 4.25 | 4 | 5 | 4 | 4 |
| EXAMPLE 13 | 0.22 | 0.36 | 4.75 | 5 | 5 | 5 | 4 |
| EXAMPLE 14 | 0.23 | 0.37 | 5 | 5 | 5 | 5 | 5 |
| EXAMPLE 15 | 0.24 | 0.44 | 4.75 | 4 | 5 | 5 | 5 |
| EXAMPLE 16 | 0.27 | 0.45 | 5 | 5 | 5 | 5 | 5 |
| EXAMPLE 17 | 0.25 | 0.48 | 5 | 5 | 5 | 5 | 5 |
| COMP EX 1 | 0.28 | 0.45 | 2.5 | 3 | 3 | 2 | 2 |
| COMP EX 2 | 0.24 | 0.48 | 3 | 3 | 3 | 3 | 3 |

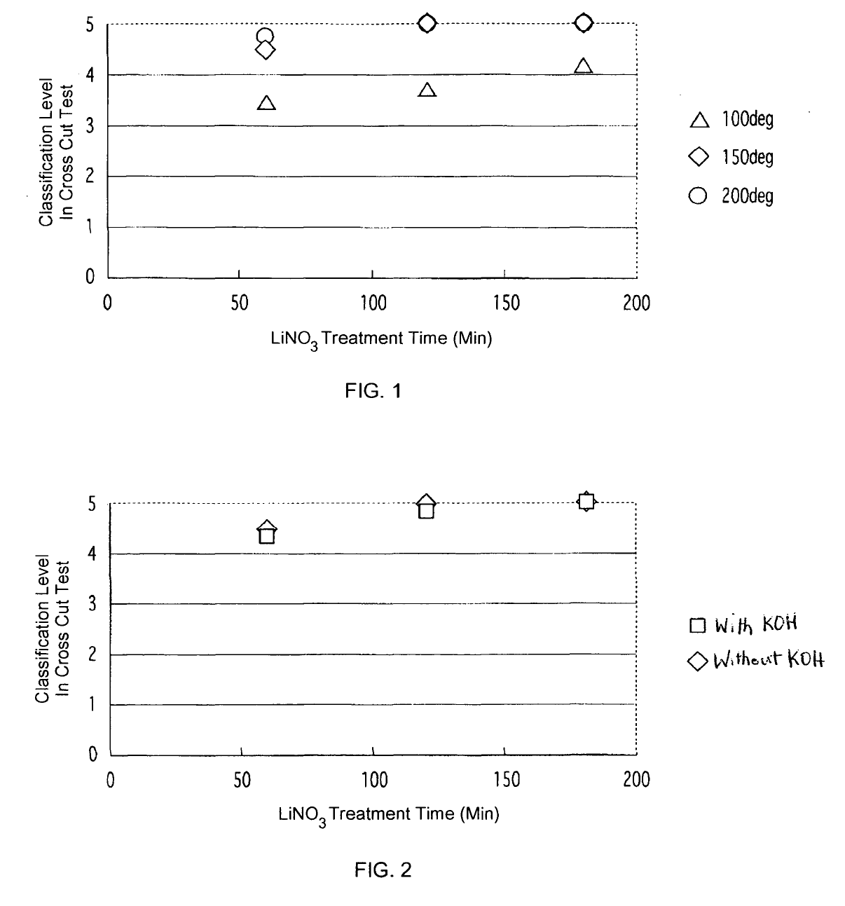

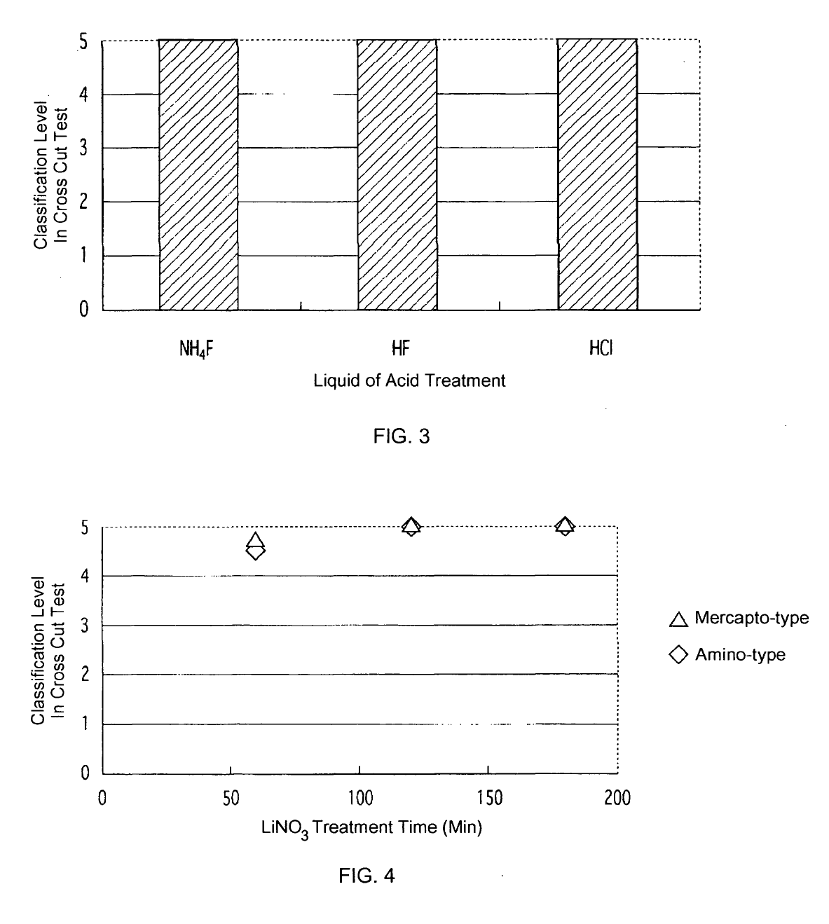

FIG. 1 shows the effects of treatment time and treatment liquid temperature in the alkali removal step on the classification level in the cross-cut test obtained in the Examples 1-9. FIG. 2 shows the effect of the pre-etching treatment at each treatment time of the alkali removal step obtained in the cross-cut tests for Examples 4-6 and 12-14. FIG. 3 shows the effect of the type of the treatment liquid in the etching step (2) on the classification level in the cross-cut test. FIG. 4 shows a comparison between the combination of amino-type silane coupling agent and palladium chloride and the combination of mercapto-type silane coupling agent and palladium.

Table 2 clearly demonstrates that the adhesivity has been improved in all of the Examples 1-17 as compared with Comparative Examples 1 and 2 in which the alkali removal treatment was omitted. Indeed, whereas Comparative Examples fell between level 2 and 3, Examples 3-17 achieved level 5. Every evaluated medium exhibited level 5 in the Examples 5, 6, 8-11, 14, 16, and 17, proving excellent adhesivity.

Every surface roughness of the glass substrate of the Examples 1-17 is less than 0.5 nm after the surface treatment steps, demonstrating no problem in the medium using the substrate. Thus, a magnetic recording medium and a magnetic recording device obtained according to the above described method exhibit high reliability in magnetic recording and useful for an external storage device of the computer.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

This application is based on, and claims priority to, Japanese Application. 2004-174690, filed on Jun. 11, 2004, and the disclosure of the priority application, in its entirety, including the drawings, claims, and the specification thereof, is incorporated herein by reference.

1. A method of treating a glass substrate for electroplating, comprising the steps of:
removing excessive alkali on a surface of the glass substrate;
etching the surface of the glass substrate from which the excessive alkali has been removed in the alkali removal step forming an adhesion layer on the glass substrate after the etching step
forming a catalyst layer using palladium chloride or palladium on the adhesion layer on the glass substrate; and
forming an electroless plating film on the catalyst layer.

2. The method according to claim 1, wherein the alkali removing step includes immersing the glass substrate in a solution containing lithium salt.

3. The method according to claim 2, wherein the etching step includes immersing the glass substrate in a solution containing hydrofluoric acid, ammonium fluoride, hydrochloric acid, or a mixture of two or more thereof.

4. The method according to claim 3, wherein the adhesion layer formation step includes immersing the glass substrate in an aqueous solution of amino-type silane coupling agent or mercapto-type silane coupling agent.

5. The method according to claim 3, wherein the etching step includes immersing the glass substrate in an aqueous solution of potassium hydroxide, before immersing the glass substrate in the solution containing hydrofluoric acid, ammonium fluoride, hydrochloric acid, or a mixture of two or more thereof.

6. The method according to claim 2, wherein temperature of the solution containing lithium salt in the alkali removal step is in a range of 100° C. to 200° C.

7. A magnetic recording medium comprising the glass substrate with the plating film according to claim 1 and a magnetic recording layer.

8. A magnetic recording device comprising a magnetic recording medium according to claim 7.

9. A method of improving adhesion between a substrate and a metal layer comprising the steps of:
removing excessive alkali on a surface of the substrate;
etching the surface of the substrate from which the excessive alkali has been removed;
forming an adhesion layer on the substrate after the etching step;
forming a catalyst layer using palladium chloride or palladium on the adhesion layer on the substrate; and
forming an electroless plating film on the catalyst layer.

10. The method according to claim 9, wherein the alkali removing step includes immersing the substrate in a solution containing lithium salt.

11. The method according to claim 10, wherein the etching step includes immersing the substrate in a solution containing hydrofluoric acid, ammonium fluoride, hydrochloric acid, or a mixture of two or more thereof.

12. The method according to claim 11, wherein the adhesion layer formation step includes immersing the substrate in an aqueous solution of amino-type silane coupling agent or mercapto-type silane coupling agent.

13. The method according to claim 11, wherein the etching step includes immersing the substrate in an aqueous solution of potassium hydroxide, before immersing the substrate in the solution containing hydrofluoric acid, ammonium fluoride, hydrochloric acid, or a mixture of two or more thereof.

14. The method according to claim 9, wherein the substrate is made of glass.

15. The method according to claim 10, wherein the substrate is made of glass.

16. The method according to claim 11, wherein the substrate is made of glass.

17. The method according to claim 12, wherein the substrate is made of glass.

18. The method according to claim 13, wherein the substrate is made of glass.

19. A magnetic recording medium made according to the method of claim 1.

20. A magnetic recording device containing a magnetic recording medium according to claim 19.
